(19) United States
(12) Patent Application Publication
(10) Pub. No.: US 2013/0158712 A1
(43) Pub. Date: Jun. 20, 2013

(54) WALKING ROBOT AND CONTROL METHOD THEREOF

(71) Applicant: SAMSUNG ELECTRONICS CO., LTD., Suwon-si (KR)

(72) Inventors: Ju Suk Lee, Hwaseong-si (KR); Kyung Shik Roh, Seongnam-si (KR)

(73) Assignee: SAMSUNG ELECTRONICS CO., LTD., Suwon-si (KR)

(21) Appl. No.: 13/685,836

(22) Filed: Nov. 27, 2012

(30) Foreign Application Priority Data
Dec. 16, 2011 (KR) 10-2011-0136019

(51) Int. Cl. G05B 19/04

(52) U.S. Cl. CPC G05B 19/04; Y10S 901/01
USPC 700/261; 901/1

(57) ABSTRACT

A walking robot includes hip joints of plural legs, a pose detector to detect a pose, a walking state judger to judge a walking state from the pose, a target angle trajectory generator to judge support and swing legs based on the walking state, to judge whether or not the swing leg contacts a surface prior to a prestored time, to shorten the next support cycle executed by the swing leg upon judging that the swing leg contacts a surface prior to the prestored time, and to generate target angle trajectories of the hip joints based on the shortened support cycle, a torque calculator to calculate torques tracking the target angle trajectories, and a controller to output the torques to the hip joint to control walking of the walking robot.

### CROSS-REFERENCE TO RELATED APPLICATIONS

This application claims priority benefit of Korean Patent Application No. 2011-0136019, filed on Dec. 16, 2011 in the Korean Intellectual Property Office, the disclosure of which is incorporated herein by reference.

### BACKGROUND

1. Field

One or more embodiments relate to a walking robot which controls driving of joints provided at plural legs to execute stable walking, and a control method thereof.

2. Description of the Related Art

In general, robots are machines which have a joint system similar to that of humans and perform the same motions as humans using such a joint system.

Industrial robots for automation and unmanned operation of production in factories were the first to be introduced. Recently, vigorous development of service robots to supply various services to humans is underway. Some of such service robots supply services to humans while performing walking.

As methods to control walking of these robots, there are a position-based Zero Moment Point (hereinafter, referred to as ZMP) control method in which joints of a robot are controlled so as to track target positions of the joints, and a torque-based dynamic walking control method and a Finite State Machine (hereinafter, referred to as FSM) control method in which joints of a robot are controlled so as to track target torques of the joints.

In the ZMP control method, a walking direction, a stride and a walking velocity of a robot are set in advance such that if a ZMP is present in a safety region within a support polygon (which is formed by (a) supporting leg(s), if the robot is supported by one leg, this means a region of the leg, and if the robot is supported by two legs, this means a region formed by the two legs), walking patterns of the respective legs corresponding to the set factors are generated, walking trajectories of the respective legs are calculated based on the walking patterns, positions of joints of the respective legs are calculated through inverse kinematics of the calculated walking trajectories, target control values of the respective joints are calculated based on current positions and target positions of the respective joints, and the joints are controlled to track the calculated target control values.

The ZMP control method achieves precise position control, but requires high servo gain and high current to execute precise angle control of the respective joints, has low energy efficiency and high stiffness of the joints, and thus may apply large impact to an object when the robot collides with the corresponding object.

Further, the ZMP control method needs to avoid kinematic singularities when the angles of the respective joints are calculated through inverse kinematics, and thus causes the robot to execute walking while maintaining a gait with bent knees.

In the torque-based dynamic walking control method, whether or not positions of respective legs of a robot precisely track walking trajectories according to walking patterns per control time during walking is detected, and torques of motors are adjusted by calculating a dynamic equation based on the detected walking trajectories, thereby causing the respective legs to precisely track the walking trajectories.

Such a torque-based dynamic walking control method is not applicable to robots having 6 degrees of freedom or more due to the complicated dynamic equation.

In the FSM control method, a finite number of operating states of a robot according to walking is defined in advance, target torques of respective joints are calculated based on the respective operating states during walking, and the joints are controlled so as to track the target torques.

Such an FSM control method executes control according to a torque command, attains high energy efficiency and low stiffness of the joints, is safe with respect to the surrounding environment, does not require calculation of inverse kinematics, and thus may perform control even at singular points, thus allowing the robot to have a natural gait with stretched knees. However, the FSM control method does not execute precise position control, thereby causing a difficulty in performing a motion, such as a climbing a stairway or avoiding an obstacle.

Further, the FSM control method causes unstable walking motions when a walking velocity is adjusted during control of walking, and requires a long time to calculate torques for optimized walking.

Moreover, if a foot of the robot contacts a surface early by external force applied to the robot during walking, the robot moves unnaturally.

### SUMMARY

The foregoing described problems may be overcome and/or other aspects may be achieved by one or more embodiments of a walking robot in which time of a next knot point of a hip joint is corrected so as to perform stable walking if a swing leg contacts a surface early due to application of external force or change of an environment, and a control method thereof.

The foregoing described problems may be overcome and/or other aspects may be achieved by one or more embodiments of a walking robot in which an angle or time of a knot point of a hip joint is corrected based on the center of mass (COM) so as to perform stable walking if external force is applied or an environment is changed, and a control method thereof.

Additional aspects and/or advantages of one or more embodiments will be set forth in part in the description which follows and, in part, will be apparent from the description, or may be learned by practice of one or more embodiments of disclosure. One or more embodiments are inclusive of such additional aspects.

In accordance with one aspect of one or more embodiments, a walking robot may include hip joints respectively provided at plural legs, a pose detector to detect a pose of the walking robot, a walking state judger to judge a walking state from the pose, a target angle trajectory generator to judge a support leg and a swing leg based on the walking state, to judge whether or not the swing leg contacts a surface prior to a prestored time when the walking state of the plural legs is changed, to shorten the next support cycle executed by the swing leg upon judging that the swing leg contacts a surface prior to the prestored time, and to generate target angle trajectories of the hip joints based on the shortened support cycle, a torque calculator to calculate torques tracking the target angle trajectories of the hip joints, and a controller to output the torques to the hip joint to control walking of the walking robot.

The target angle trajectory generator may generate plural knot points within the next support cycle based on the pose during a swing cycle when one of the plural legs is in a swing state.

The target angle trajectory generator may shorten time at the first knot point of the next support cycle of the hip joint of the swing leg based on an angle difference between an angle when the swing leg contacts a surface and an angle at the first knot point of the next support cycle, upon judging that the swing leg contacts a surface prior to the prestored time.

The target angle trajectory generator may shorten time at the final knot point of the next support cycle of the hip joint of the swing leg based on an angle difference between an angle when the swing leg contacts a surface and an angle at the final knot point of the next support cycle, upon judging that the swing leg contacts a surface prior to the prestored time.

The knot points may include at least one of a pitch knot point and a roll knot point of the hip joint.

The pose detector may include force and torque (F/T) sensors to detect forces/torques transmitted to feet of the plural legs, and the walking state judger may judge the support leg and the swing leg based on the forces/torques transmitted to the feet.

The target angle trajectory generator may judge time at a knot point when the swing leg normally contacts the ground, and may prestore the time.

The target angle trajectory generator may judge whether or not the swing leg contacts a surface prior to the prestored time by comparing time when the swing leg actually contacts a surface with time when the swing leg normally contacts the ground.

In accordance with another aspect of one or more embodiments, a walking robot may include hip joints respectively provided at plural legs, a pose detector to detect a pose of the walking robot, a walking state judger to judge a walking state from the pose, a target angle trajectory generator to judge a support leg and a swing leg based on the walking state, to generate the knot points of the hip joints of the respective legs according to time, to calculate angle and time compensation values of the next knot points by detecting the COM from the pose, to correct times and angles at the next knot points based on the angle and time compensation values, and to generate target angle trajectories of the hip joints using the next knot points with the corrected times and angles, a torque calculator to calculate torques tracking the target angle trajectories of the hip joints, and a controller to output the torques to the hip joints to control walking of the walking robot.

The target angle trajectory generator may correct time and angle of the next knot point of the swing leg.

The target angle trajectory generator may generate a target angle trajectory by connecting roll knot points of the hip joint by a spline.

The target angle trajectory generator may judge variation of the COM in the Y-axis direction, and may calculate roll angle and time compensation values by comparing the judged variation of the COM in the Y-axis direction with a reference variation of the COM in the Y-axis direction.

The target angle trajectory generator may judge whether or not the swing leg contacts a surface prior to a prestored time based on the walking state, may shorten the next support cycle executed by the swing leg upon judging that the swing leg contacts a surface prior to the prestored time, and may generate the target angle trajectory of the hip joint of the swing leg based on the shortened support cycle.

The target angle trajectory may be a target pitch angle trajectory of the hip joint of the swing leg.

The target angle trajectory generator may calculate time of the next support cycle based on an angle when the swing leg contacts the ground, a walking velocity and a prestored leg length upon judging that the swing leg contacts a surface prior to the prestored time.

The target angle trajectory generator may calculate time of the next support cycle based on a pitch angle when the swing leg contacts the ground, a walking velocity and the height of the COM upon judging that the swing leg contacts a surface prior to the prestored time.

In accordance with another aspect of one or more embodiments, a control method of a walking robot may include detecting a pose of the walking robot at the current cycle during walking with plural legs, respectively generating knot points of the plural legs within the next cycle based on the pose of the walking robot, judging a swing leg and a support leg by judging a walking state from the pose of the walking robot, judging whether or not the swing leg contacts a surface prior to a prestored time, shortening time at the knot points within the support cycle executed by the swing leg upon judging that the swing leg contacts a surface prior to the prestored time, generating target angle trajectories of the hip joints using the knot points having shortened time within the support cycle, calculating torques tracking the target angle trajectories of the hip joints, and outputting the torques to the hip joints to control walking of the walking robot.

The shortening of the time at the knot points within the support cycle may include shortening time of at least one knot point of a pitch knot point and a roll knot point of the hip joint of the swing leg.

The shortening of the time at the at least one knot point may include judging whether or not a pitch angle of the hip joint when the swing leg contacts a surface is greater than a pitch angle at the first knot point of the support cycle, calculating an angle difference between the pitch angle of the hip joint when the swing leg contacts a surface and the pitch angle at the first knot point of the support cycle, upon judging that the pitch angle of the hip joint when the swing leg contacts a surface is greater than the pitch angle at the first knot point of the support cycle, calculating time based on the angle difference, a predetermined walking velocity and a leg length of the walking robot, and shortening time at the first pitch knot point within the support cycle to the calculated time.

The shortening of the time at the at least one knot point may include judging whether or not a pitch angle of the hip joint when the swing leg contacts a surface is greater than a pitch angle at the first knot point of the support cycle, calculating an angle difference between the pitch angle of the hip joint when the swing leg contacts a surface and a pitch angle at the final knot point of the support cycle, upon judging that the pitch angle of the hip joint when the swing leg contacts a surface is less than the pitch angle at the first knot point of the support cycle, calculating time based on the angle difference, a predetermined walking velocity and a leg length of the walking robot, and shortening time at the final pitch knot point within the support cycle to the calculated time.

The generation of the target angle trajectory of the hip joint may include generating a target angle trajectory of the hip joint of the swing leg by connecting the knot points with the shortened time by a spline.

The control method may further include acquiring time at a knot point when the swing leg normally contacts a surface and prestoring the time.

The judgment as to whether or not the swing leg contacts a surface prior to a prestored time may include comparing time when the swing leg actually contacts a surface with time when the swing leg normally contacts the ground, and judging that the swing leg contacts a surface prior to a prestored time upon judging that the time when the swing leg actually contacts a surface is earlier than the time when the swing leg normally contacts the ground.

In accordance with a further aspect of one or more embodiments, a control method of a walking robot may include detecting a pose of the walking robot walking with plural legs, judging a swing leg and a support leg by judging a walking state from the pose of the walking robot, generating the next knot points of the hip joints of the respective legs according to time, calculating angle and time compensation values at the next knot points by detecting the COM of the walking robot from the pose of the walking robot, correcting times and angles at the next knot points based on the angle and time compensation values, generating target angle trajectories of the hip joints using the next knot points with the corrected times and angles, calculating torques tracking the target angle trajectories of the hip joints, and outputting the torques to the hip joints to control walking of the walking robot.

The correction of times and angles at the next knot points may include correcting time and angle at the next roll knot point of the swing leg.

The calculation of the angle and time compensation values at the next knot points may include judging variation of the COM in the Y-axis direction, and calculating roll angle and time compensation values by comparing the judged variation of the COM in the Y-axis direction with a reference variation of the COM in the Y-axis direction.

The variation of the COM in the Y-axis direction may include a distance variation of the COM in the Y-axis direction and a velocity variation of the COM in the Y-axis direction.

The control method may further include judging whether or not the swing leg contacts a surface prior to a prestored time based on the walking state, shortening time at pitch knot points within the support cycle of the swing leg upon judging that the swing leg contacts a surface prior to the prestored time, and generating a target angle trajectory of the hip joint of the swing leg using the pitch knot points with the shortened time within the support cycle.

Additional aspects and/or advantages of one or more embodiments will be set forth in part in the description which follows and, in part, will be apparent from the description, or may be learned by practice of one or more embodiments of disclosure. One or more embodiments are inclusive of such additional aspects.

### BRIEF DESCRIPTION OF THE DRAWINGS

These and/or other aspects will become apparent and more readily appreciated from the following description of the embodiments, taken in conjunction with the accompanying drawings of which:

FIG. 1 is an exemplary view illustrating an external appearance of a walking robot in accordance with one or more embodiments;

FIG. 2 is an exemplary view illustrating structures of joints of the walking robot in accordance with one or more embodiments;

FIG. 3 is a block diagram of a control apparatus of the walking robot in accordance with one or more embodiments;

FIG. 4 is an exemplary view illustrating judgment of a walking state by a walking state judger provided in the walking robot in accordance with one or more embodiments;

FIG. 5 is a flowchart illustrating a control method of the walking robot in accordance with one or more embodiments;

FIGS. 6 to 8 are exemplary views illustrating a target pitch angle trajectory of a hip joint of the right leg of the walking robot according to time during walking in accordance with one or more embodiments;

FIG. 9 is a control block diagram of a walking robot in accordance with one or more embodiments;

FIGS. 10A and 10B are exemplary views illustrating change of the COM of the walking robot in accordance with one or more embodiments;

FIG. 11 is a block diagram illustrating a detailed configuration of a target angle trajectory generator of the walking robot in accordance with one or more embodiments;

FIG. 12 is a flowchart illustrating a control method of the walking robot in accordance with one or more embodiments; and

FIG. 13 is an exemplary view illustrating a target roll angle trajectory of a hip joint of the right leg of the walking robot according to time during walking in accordance with one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein, as various changes, modifications, and equivalents of the systems, apparatuses and/or methods described herein will be understood to be included in the invention by those of ordinary skill in the art after embodiments discussed herein are understood. Accordingly, embodiments are merely described below, by referring to the figures, to explain aspects of the present invention.

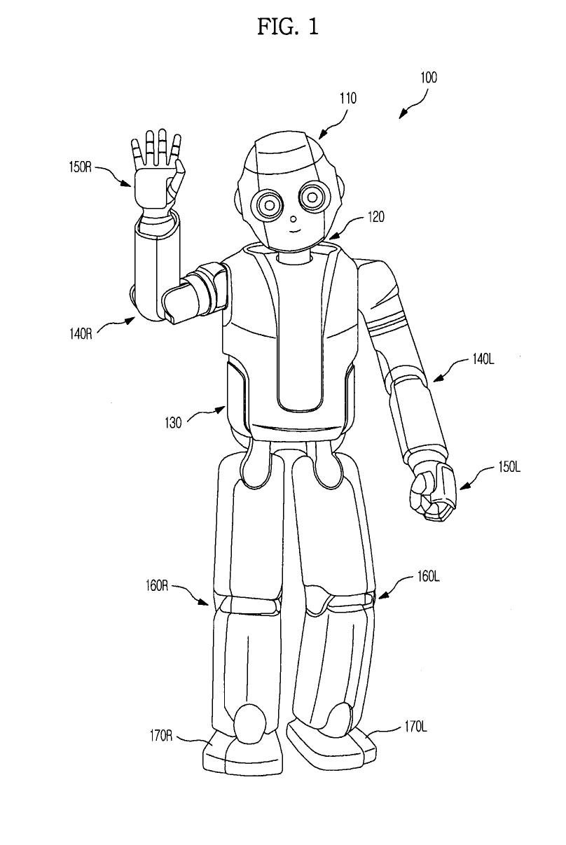

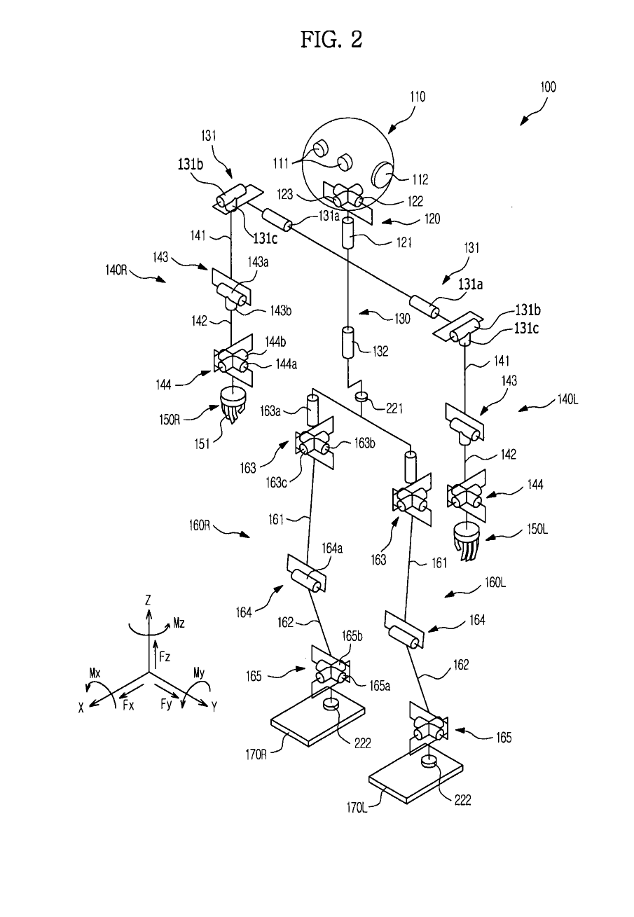

FIG. 1 is an exemplary view illustrating an external appearance of a walking robot in accordance with one or more embodiments, and FIG. 2 is an exemplary view illustrating structures of joints of the walking robot in accordance with one or more embodiments.

As shown in FIG. 1, a walking robot may include, for example, an upper body including a head 110, a neck 120, a torso 130, arms 140R and 140L and hands 150R and 150L, and a lower body including a plurality of legs 160R and 160L and feet 170R and 170L.

Covers may be provided at the outside of the upper body and the lower body, and serve to protect the respective components of the walking robot 100 from external impact.

In more detail, the upper body of the walking robot 100 may include, for example, the head 110, the torso 130 which may be connected to the lower portion of the head 110 through the neck 120, the two arms 140R and 140L which may be connected to both sides of the upper portion of the torso 130, and the hands 150R and 150L which respectively may be connected to tips of the two arms 140R and 140L.

The lower body of the walking robot 100 may include, for example, the two legs 160R and 160L which may be connected to both sides of the lower portion of the torso 130 of the upper body, and the feet 170R and 170L which respectively may be connected to tips of the two legs 160R and 160L.

Here, the head 110, the two arms 140R and 140L, the two hands 150R and 150L, the two legs 160R and 160L and the two feet 170R and 170 may respectively have designated degrees of freedom through joints.

Here, “R” and “L” may respectively indicate the right and left sides of the robot 100.

Hereinafter, the walking robot 100 will be described in more detail with reference to FIG. 2.

On or more cameras 111 to capture surrounding images and one or more microphones 112 to detect surrounding sound may be provided on the head 110.

The neck 120 may connect the head 110 and the torso 130. The neck 120 may include a neck joint having, for example, 3 degrees of freedom.

The neck joint may include a rotary joint 121 in the yaw direction (rotated around the Z-axis: Mz), a rotary joint 122 in the pitch direction (rotated around the Y-axis: My) and a rotary joint 123 in the roll direction (rotated around the X-axis: Mx). Here, motors (not shown) to rotate the head 110 may be respectively provided at the plural rotary joints 121, 122 and 123 of the neck joint.

Shoulder joints 131 to connect the two arms 140R and 140L to the torso 130 may be respectively provided at both sides of the upper portion of the torso 130, hip joints 163 to connect the two legs 160R and 160L to the torso 130 may be respectively provided at both sides of the lower portion of the torso 130, and a rotary joint 132 in the yaw direction to rotate the breast with respect to the waist may be provided between the breast and the waist of the robot 100.

The two arms 140R and 140L may respectively include upper arm links 141, lower arm links 142, elbow joints 143, and wrist joints 144.

The upper arm links 141 may be connected to the respective shoulder joints 131, the lower arm links 142 may be connected to the respective elbow joints 143, and the hands 150R and 150L may be connected to the respective wrist joints 144.

Here, each shoulder joint 131 may include a rotary joint 131a in the pitch direction, a rotary joint 131b in the roll direction and a rotary joint 131c in the yaw direction, each elbow joint 143 may include a rotary joint 143a in the pitch direction and a rotary joint 143b in the yaw direction, and each wrist joint 144 may include a rotary joint 144a in the pitch direction and a wrist joint 144b in the roll direction.

That is, the shoulder joints 131 respectively may have 3 degrees of freedom, the elbow joints 143 respectively may have 2 degrees of freedom, and the wrist joints 144 respectively may have 2 degrees of freedom.

The hands 150R and 150L may be respectively provided with five fingers 151. A plurality of joints (not shown) driven by motors may be provided on the respective fingers 151. The fingers 151 may perform various motions, such as gripping an article or pointing in a specific direction, in connection with movement of the arms 140R and 140L.

The two legs 160R and 160L of the walking robot 100 respectively may include thigh links 161, calf links 162, the hip joints 163, knee joints 164, and ankle joints 165.

The thigh links 161 may be connected to the respective hip joints 163, the calf links 162 may be connected to the respective knee joints 164, and the feet 170R and 170L may be connected to the respective ankle joints 165.

Each hip joint 163 may include a rotary joint 163a in the yaw direction (rotated around the Z-axis), a rotary joint 163b in the pitch direction (rotated around the Y-axis) and a rotary joint 163c in the roll direction (rotated around the X-axis), each knee joint 164 may include a rotary joint 164a in the pitch direction, and each ankle joint 165 may include a rotary joint 165a in the pitch direction and a rotary joint 165b in the roll direction.

That is, the hip joints 163 respectively may have 3 degrees of freedom, the knee joints 164 respectively may have 1 degree of freedom, and the ankle joints 165 respectively may have 2 degrees of freedom.

As described above, because the two legs 160R and 160L may respectively include 6 rotary joints of the three joints 163, 164 and 165, a total of 12 rotary joints may be provided to the two legs 160R and 160L.

Actuators, such as motors (not shown), may be provided at the respective rotary joints of the walking robot 100. Thereby, the respective rotary joints may properly perform rotating motion due to rotation of the motors, thus possibly allowing the walking robot 100 to achieve various motions and to possibly perform stable and natural walking while maintaining balance during walking.

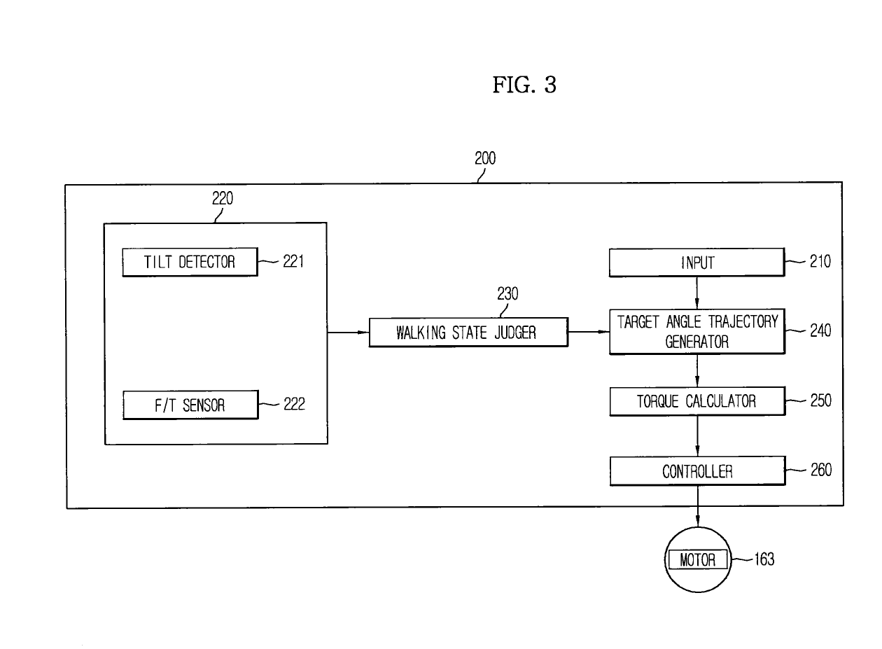

Hereinafter, walking of the walking robot 100 will be described in detail with reference to FIG. 3.

FIG. 3 is a block diagram of a walking control apparatus 200 of the walking robot in accordance with one or more embodiments. The walking control apparatus 200 of the walking robot may include, for example, an input 210, a pose detector 220, a walking state judger 230, a target angle trajectory generator 240, a torque calculator 250, and a controller 260.

The input 210 may receive a walking command and a walking velocity of the walking robot from a user. Here, the input 210 may have the function of a communication unit to receive a walking command and a walking velocity of the walking robot transmitted from the outside.

Further, the walking velocity may be set in advance.

That is, the walking robot may drive the plural motors (not shown) installed on the respective joints 163, 164 and 165 based on the user command input through the input 210 and the pose of the walking robot, thereby possibly executing stable walking at the walking velocity corresponding to the user command.

The pose detector 220 may detect the pose of the walking robot and may transmit the detected pose data to the walking state judger 230. Here, the pose data of the walking robot may be data as to whether or not the feet of the robot contact a surface and data as to a support leg and a swing leg corresponding to whether or not the feet of the robot contact the ground.

The pose detector 220 may include, for example, a tilt detector 221 to detect a tilt of the upper body of the walking robot, and multi-axis force and torque (F/T) sensors 222 to detect whether or not the feet 170R and 170L contact a surface and a support leg and a swing leg corresponding to whether or not the feet 170R and 170L contact the ground.

The tilt detector 22 may be located on the torso 130, and may detect the tilt of the upper body with respect to the vertical line, i.e., rotating angles of three axes in the pitch, roll and yaw directions and their angular velocities. Here, the tilt detector 22 may include an inertial measurement unit (IMU) to measure inertia.

Here, the rotating angles of the respective joints may be measured using RPMs of plural motors (not shown) provided at the respective joints. The RPMs of the respective motors may be detected through encoders (not shown) connected to the respective motors.

The multi-axis F/T sensors 222 may be respectively installed between the legs 160R and 160L and the feet 170R and 170L, and may detect loads applied to the feet 170R and 170L.

The multi-axis F/T sensors 222 may measure three directional components Fx, Fy, and Fz of force and three directional components Mx, My, and Mz of moment transmitted to the feet 170R and 170L, and may transmit the measured data to the walking state judger 230.

The walking state judger 230 may judge whether or not the feet 170R and 170L contact a surface based on the loads applied to the respective feet 170R and 170L detected by the multi-axis F/T sensors 222 of the pose detector 220, may judge a leg, the load of which is detected, to be a support leg and a leg, the load of which is not detected, to be a swing leg.

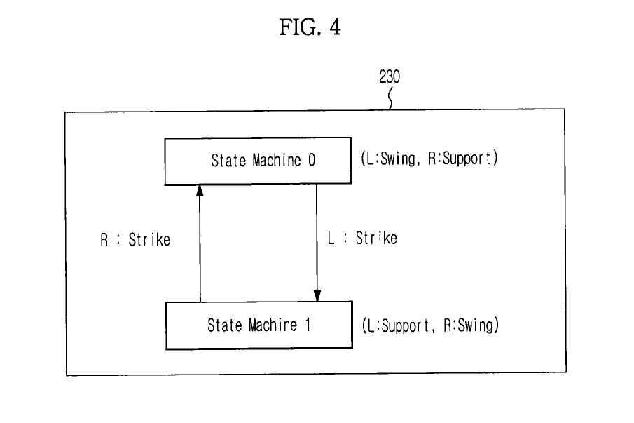

This will be described with reference to FIG. 4.

FIG. 4 is an exemplary view illustrating judgment of the walking state by the walking state judger 230 that may be provided in the walking control apparatus 200 of the robot in accordance with one or more embodiments.

Upon judging that load is applied to the feet of the right leg, the walking state judger 230 may judge the right leg to be in the support state and the left leg to be in the swing state and may recognize such a state as a ‘state machine 0’, and upon judging that load is applied to the foot of the left leg, the walking state judger 230 may judge the left leg to be in the support state and the right leg to be in the swing state and may recognize such a state as a ‘state machine 1’. Then, the walking state judger 230 may transmit the recognized data to the target angle trajectory generator 240.

Such a walking state judger 230 may store walking state data of the two legs based on the finite state machine (FSM). Here, the FSM may sequentially illustrate limited state change of the two legs.

That is, the respective legs of the walking robot may alternately repeat the swing state and support state based on the FSM during walking, and may execute different states.

The target angle trajectory generator 240 may determine rotating angles of the plural rotary joints to execute the next stride based on the current walking state data of the respective legs judged by the walking state judger 230 and the walking velocity input through the input 210, may calculate knot points of the plural rotary joints based on the rotating angles of the plural rotary joints provided at the respective joints 163, 164 and 165, and may generate target angle trajectories of the plural rotary joints by connecting the calculated target knot points by splines.

Here, the target angle trajectories may include a support trajectory to execute the support state and a swing trajectory to execute the swing state. That is, the target angle trajectory generator 240 may repeatedly generate the support trajectory and the swing trajectory based on the pose and the walking velocity of the robot.

A section formed by the swing trajectory corresponding to the swing state is referred to as a swing cycle, and a section formed by the support trajectory corresponding to the support state is referred to as a support cycle.

The target angle trajectory generator 240 may generate values between the knot points using a spline function. Thereby, the plural knot points may be connected through a spline. For example, the spline function may include, for example, a fifth-order quintic spline function, a third-order cubic spline function, and a Catmull-Rom spline function.

The target angle trajectory generator 240 may compare time when the swing leg actually contacts a surface with time at a knot point when the swing leg normally contacts the ground, and may judge that the swing leg contacts a surface prior to a prestored time, if the time when the swing leg actually contacts a surface is earlier than the time at the knot point when the swing leg normally contacts the ground.

Here, the prestored time may be a time at the knot point when the swing leg normally contacts the ground. The target angle trajectory generator 240 may judge the time at the knot point when the swing leg normally contacts the ground, and may prestore the time at the knot point when the swing leg normally contacts the ground.

Upon judging that the swing leg contacts a surface prior to the prestored time by, for example, environmental change or application of external force, the target angle trajectory generator 240 may shorten the support cycle which will be executed next by the swing leg, and may connect knot points within the shortened support cycle through a spline, thereby generating a target angle trajectory of the hip joint.

Here, shortening of the support cycle may mean shortening of the overall cycle by shortening time of knot points within the next support cycle when the swing leg normally contacts a surface based on a point of time when the swing leg contacts the ground.

If the swing leg contacts a surface early, as described above, deceleration of the walking velocity may be prevented by shortening the time at the knot points within the next support cycle.

Here, a knot point may be at least one of a pitch knot point and a roll knot point of the hip joint, and a target angle trajectory may be at least one of a target pitch angle trajectory and a target roll angle trajectory of the hip joint.

The target angle trajectory generator 240 may respectively transmit the target pitch angle trajectories and the target roll angle trajectories to the torque calculator 250.

The torque calculator 250 may respectively calculate torques to track the target pitch angle trajectories and the target roll angle trajectories of the hip joints 163 of the respective legs transmitted from the target angle trajectory generator 240.

When the torque calculator 250 calculates torques of the respective rotary joints provided at the hip joints 163 of the respective legs, Proportional-Derivative (PD) control may be used.

Here, torque is rotary force of a motor (not shown) to track a target angle.

The controller 260 may execute pulse width modulation (PWM) of current corresponding to the torques calculated by the torque calculator 250 to generate the calculated torques, and may respectively output current controlled by PWM to the motors (not shown) provided at the hip joints 163.

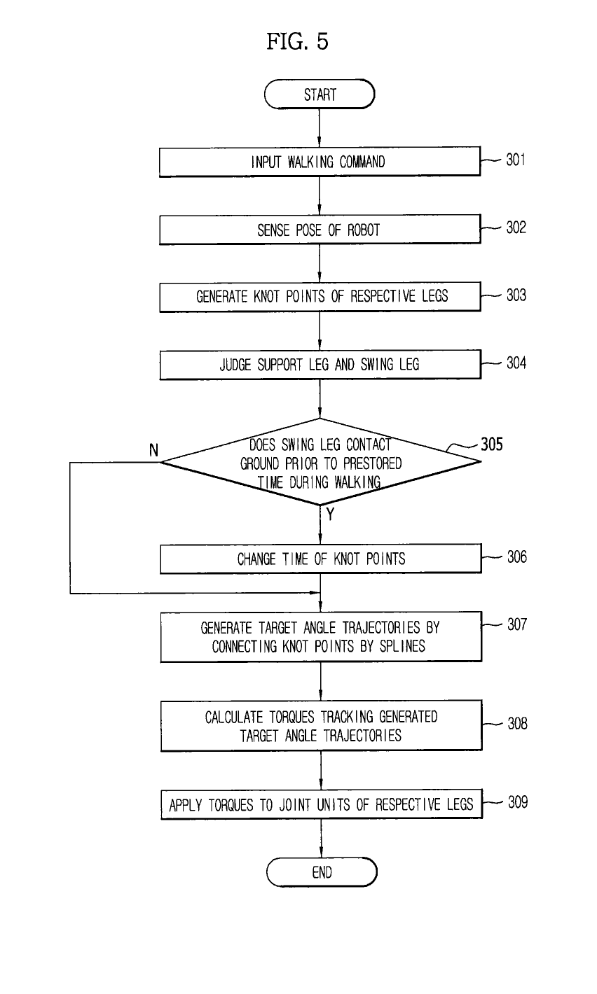

FIG. 5 is a flowchart illustrating a control method of the walking robot in accordance with one or more embodiments. Hereinafter, the control method of the walking robot will be described with reference to FIGS. 5 to 8.

When a walking command is input through the input 210 (Operation 301), the walking robot 100 may control walking at a predetermined walking velocity. Further, the walking robot 100 may receive a walking velocity through the input 210.

The walking robot 100 may execute walking based on the current target angle trajectories of the respective legs, and may detect a pose during walking (Operation 302).

Thereafter, the walking robot 100 may generate knot points of the respective legs based on the detected pose in order to execute the next walking cycle (Operation 303).

For example, if, in the current walking cycle, the right leg in the swing state and the left leg is in the support state, knot points in the support state of the right leg may be generated and knot points in the swing state of the left leg may be generated in order to execute the next walking cycle.

That is, knot points within the support cycle executing the support state and knot points within the swing cycle executing the swing state may be generated.

The knot points within the swing cycle and the support cycle of the target angle trajectory of one leg may be generated based on the walking progress state, and thus may have different time values.

Here, the knot points of the plural rotary joints of the respective joints provided at the respective legs may respectively be generated.

The walking robot 100 may judge time when the swing leg normally contacts a surface during generation of knot points of the respective legs to execute the next walking cycle, and may store the time.

Further, time when the swing leg normally contacts a surface at the current walking cycle may be judged and then may be stored at the previous walking cycle.

The walking robot 100 may judge a support leg contacting a surface to support the body of the walking robot 100 and a swing leg lifted off a surface to swing in a space based on the loads applied to the respective ankles (Operation 304).

The walking robot 100 may judge whether or not the swing leg contacts a surface prior to the prestored time according to, for example, environmental change or application of external force (Operation 305).

For this purpose, upon judging that the swing leg contacts a surface based on the result of judgment of the support leg and the swing leg, the walking robot 100 may compare time when the swing leg actually contacts a surface with time when the swing leg normally contacts the ground.

If the time when the swing leg actually contacts a surface is earlier than the time when the swing leg normally contacts the ground, the walking robot 100 may judge that the swing leg contacts a surface prior to the prestored time.

Thereafter, upon judging that the swing leg contacts a surface at the prestored time, the walking robot 100 may maintain the time values of the knot points of the next cycle, i.e., the support cycle, of the swing leg contacting the ground.

On the other hand, upon judging that the swing leg contacts a surface prior to the prestored time according to, for example, environmental change or application of external force, the walking robot 100 may shorten the next cycle, i.e., the support cycle, of the swing leg contacting a surface early.

In more detail, the walking robot 100 may shorten time of knot points within the next support cycle when the swing leg normally contacts a surface based on time when the swing leg actually contacts a surface (Operation 306), thereby shortening the overall support cycle.

Thereafter, the walking robot 100 may generate target angle trajectories by connecting the knot points by splines (Operation 307).

Thereafter, the walking robot 100 may respectively calculate torques to track the target angle trajectories of the joints 163, 164 and 165 of the respective legs (Operation 308).

Thereafter, the walking robot 100 may execute pulse width modulation (PWM) of current to respectively output the calculated torques, and may respectively apply current controlled by PWM to the motors (not shown) of the plural rotary joints provided at the respective joints 163, 164 and 165 (Operation 309), thereby rotating the plural motors. The walking robot 100 may execute walking by rotation of the plural motors.

During calculation of the torques applied to the motors, the walking robot 100 may use Proportional-Derivative (PD) control, and a torque calculation equation may be as follows.

τ=kp(θd−θc)+kd(θd′−θc′)

Here, kp is P gain of PD control, kd is D gain of PD control, θd is a target angle, and θc is a current angle. Further, the P and D grains may enable the walking robot 100 to stably walk, and may be obtained through experimentation.

Here, torque is rotary force of a motor (not shown) to track a target angle.

In this embodiment, a knot point may be at least one of a pitch knot point and a roll knot point of the hip joint, a target angle trajectory may be at least one of a target pitch angle trajectory and a target roll angle trajectory of the hip joint, and torque may be at least one of torque applied to the pitch rotary joint of the hip joint and torque applied to the roll rotary joint of the hip joint.

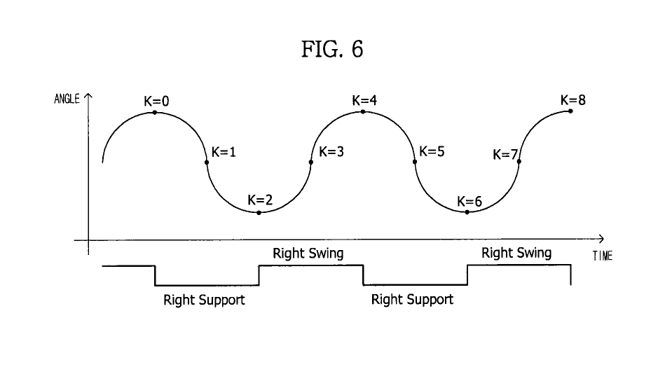

Hereinafter, with reference to FIGS. 6 to 8, generation of knot points and generation of a target angle trajectory according to time when the swing leg contacts a surface will be described.

FIG. 6 is an exemplary view of a target pitch angle trajectory of the hip joint 163 of the right leg 160R, and illustrating knot points and the target pitch angle trajectory when the right leg 160R, i.e., the swing leg, normally contacts the ground.

The right leg 160R of the walking robot 100 may alternately repeat the swing state and the support state, and may execute a different motion from the left leg 160L. Here, when the right leg 160R is in the support state, the right leg 160R may generate pitch knot points within the next swing cycle while executing a motion for supporting during the support cycle, and when the right leg 160R is in the swing state, the right leg 160R may generate pitch knot points within the next support cycle while executing a motion for swinging during the swing cycle.

As shown in FIG. 6, the walking robot may execute support through the right leg while tracking a target angle trajectory formed by connecting pitch knot points (K=0, 1, 2) generated at a point of time when the foot contacts the ground, at a point of time when the heel and the toe of the foot touch the ground, and at a point of time when the foot is lifted off a surface during the support cycle, and may generate pitch knot points to execute the next state based on the pose during execution of support.

Here, the next state may be referred to as a state in which swing through the right leg is executed, and the walking robot may generate pitch knot points (K=3, 4) within the swing cycle of the right leg. That is, the walking robot may generate pitch knot points (K=3, 4) at a point of time when the foot swings and at a point of time when the foot contacts the ground.

When the left foot contacts the ground, the walking robot may generate a target pitch angle trajectory during the swing cycle by connecting the pitch knot point (K=2) at the point of time when the foot is lifted off a surface and the newly generated pitch knot points (K=3, 4), may execute swing through the right leg while tracking the target pitch angle trajectory during the swing cycle, and may generate pitch knot points to execute the next state based on the pose during execution of swing.

Here, the next state may be a state in which support through the right leg is executed, and the walking robot generates pitch knot points (K=5, 6) within the support cycle of the right leg. That is, the walking robot may generate pitch knot points (K=5, 6) at a point of time when the heel and the toe of the foot touch a surface and at a point of time when the foot is lifted off the ground.

When the swing leg, i.e., the right foot, normally contacts the ground, the walking robot may generate a target pitch angle trajectory during the support cycle by connecting the pitch knot point (K=4) at the point of time when the foot contacts a surface and the newly generated pitch knot points (K=5, 6), may execute support through the right leg while tracking the target pitch angle trajectory during the support cycle, and may generate pitch knot points (K=7, 8) to execute the next state based on the pose during execution of support.

That is, the robot may execute support at the pitch knot points (K=0, 1, 2), may execute swing at the pitch knot points (K=2, 3, 4), may re-execute support at the pitch knot points (K=4, 5, 6), and may re-execute swing at the pitch knot points (K=6, 7, 8).

The walking robot may stably walk by repeating such a process.

Here, the pitch knot points (K=1, 2, 4, 6, 8) may be pitch knot points when the swing state and the support state intersect, a section of the pitch knot points (K=0, 1, 2) and a section of the pitch knot points (K=4, 5, 6) may correspond to the support cycle, and a section of the pitch knot points (K=2, 3, 4) and a section of the pitch knot points (K=6, 7, 8) may correspond to the swing cycle.

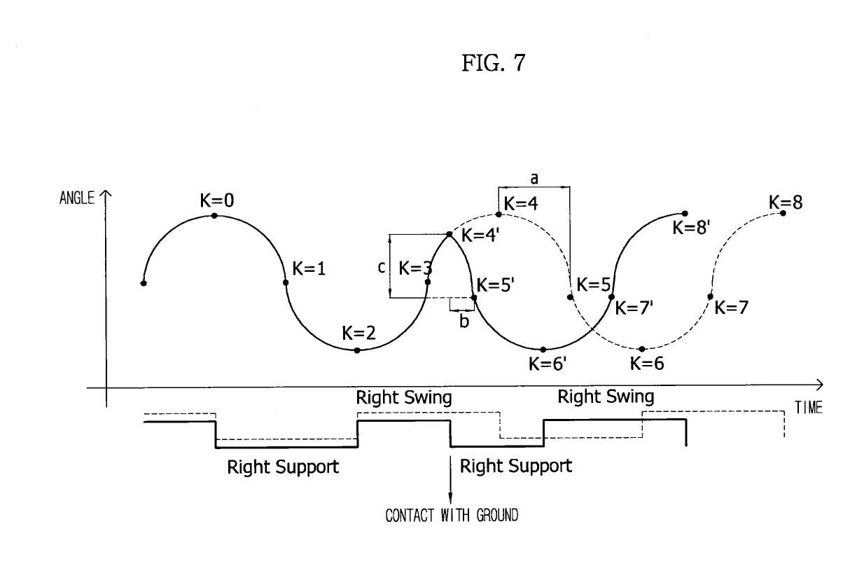

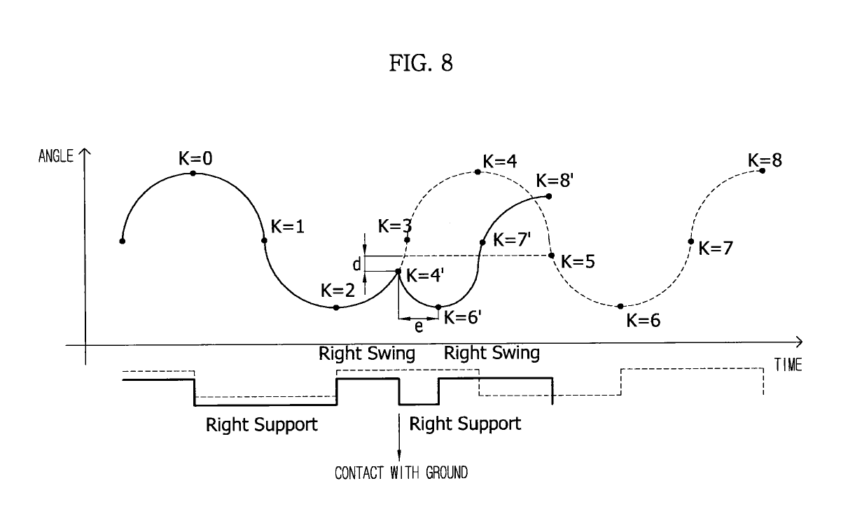

FIGS. 7 and 8 are exemplary views of target pitch angle trajectories of the hip joint 163 of the right leg 160R, and illustrating knot points and the target pitch angle trajectories when the right leg, i.e., the swing leg, contacts a surface prior to the prestored time.

The walking robot may execute support through the right leg while tracking a target pitch angle trajectory formed by connecting pitch knot points (K=0, 1, 2) within the support cycle, and may generate pitch knot points to execute the next state, i.e., the swing state, based on the pose during execution of support.

Here, the walking robot may generate pitch knot points (K=3, 4) at a point of time when the foot swings and at a point of time when the foot contacts the ground.

When the left leg contacts the ground, the walking robot may generate a target pitch angle trajectory during the swing cycle by connecting the pitch knot point (K=2) at the point of time when the foot is lifted off a surface and the newly generated pitch knot points (K=3, 4).

Further, the walking robot may judge a time when the swing cycle of the right leg is switched into the support cycle, i.e., a time when the right leg contacts a surface (i.e., time at the knot point (K=4)), and then may store such a time.

The walking robot may execute swing through the right leg while tracking the target pitch angle trajectory during the swing cycle, and may generate pitch knot points to execute the next state, i.e., the support state, based on the pose during execution of swing.

That is, the walking robot may generate pitch knot points (K=5, 6) at a point of time when the heel and the toe of the foot touch a surface and at a point of time when the foot is lifted off the ground.

The walking robot may judge whether or not the right leg contacts a surface prior to the prestored time during swing of the right leg.

In more detail, when the swinging right leg contacts the ground, the walking robot may judge time when the right leg contacts the ground, may compare time when the right leg actually contacts a surface (time at the knot point (K=4′)) with the predetermined time (time at the knot point (K=4), and may judge that the swinging right leg contacts a surface prior to the predetermined time, if the time when the right leg actually contacts a surface is earlier than the predetermined time.

Upon judging that the swinging right leg contacts a surface prior to the predetermined time, the walking robot may generate the knot point (K=4′) at the point of time when the right leg actually contact the ground, and may shorten the next support cycle in order to prevent decrease of the walking velocity due to early contact of the swing leg with the ground.

Here, shortening of the support cycle may mean shortening time of knot points within the support cycle.

As shown in FIGS. 7 and 8, when the swing cycle is switched into the support cycle, decrease of the pitch angle of the hip joint may be carried out.

Thereby, if the current pitch angle of the hip joint is greater than the pitch angle at the first knot point of the support cycle under the condition that the swing leg contacts a surface early, decrease of the pitch angle from the current pitch angle of the hip joint to the pitch angle at the first knot point of the support cycle may be enabled.

However, if the current pitch angle of the hip joint is less than the pitch angle at the first knot point of the support cycle under the condition that the swing leg contacts a surface early, pitch angle control from the current pitch angle of the hip joint to the pitch angle at the first knot point of the support cycle may be disabled. Therefore, the pitch angle of the hip joint may be controlled based on the pitch angle at a pitch knot point having the minimum pitch angle within the support cycle, i.e., at a pitch knot point at a point of time when the foot is lifted off the ground.

Here, the reason why pitch angle control may be disabled when the current pitch angle of the hip joint is less than the pitch angle at the first knot point of the support cycle is that in order to execute the support cycle, pitch angle increase from the current pitch angle of the hip joint to the pitch angle at the first knot point of the support cycle may be carried out or pitch angle delay may be carried out until the pitch angle of the support cycle reaches the current pitch angle, when pitch angle increase is carried out, the two legs may be in the swing state, and when pitch angle delay is carried out, the right leg may enter a stopped state.

In consideration of the above aspect, shortening of the support cycle will be exemplarily described in detail with reference to FIGS. 7 and 8.

FIG. 7 is an exemplary view illustrating angle control from the current pitch angle of the hip joint to the pitch angle at the first pitch knot point within the support cycle if the current pitch angle of the hip joint is greater than the pitch angle at the first pitch knot point within the support cycle (c>0) under the condition that the swing leg contacts a surface early.

As shown in FIG. 7, the walking robot may generate a pitch knot point (K=5′) formed by shortening time at the pitch knot point (K=5) within the next support cycle.

In more detail, if the swinging right leg normally contacts the ground, time required for control from the angle at the pitch knot point (K=4) to the angle at the pitch knot point (K=5) may be a.

However, if the swinging right leg contacts a surface early, when control from the angle at the newly generated pitch knot point (K=4′) to the angle at the pitch knot point (K=5) is carried out for the time a, the walking velocity may decrease. Therefore, in order to maintain the walking velocity, a time value at the next knot point may need to be adjusted.

The reason for possible decrease of the walking velocity is that the angle at the newly generated pitch knot point (K=4′) may be smaller than the angle at the pitch knot point (K=4), an angle variation between the pitch knot point (K=4′) and the next pitch knot point (K=5) may be smaller than an angle variation between the pitch knot point (K=4) and the next pitch knot point (K=5), and thus, the smaller angle variation may be controlled for the same time a if the swinging right leg contacts a surface early.

Therefore, the time at the next pitch knot point (K=5) may be shortened.

Here, an angle difference c between the pitch angle at the pitch knot point (K=4′) at the point of time when the foot actually contacts a surface and the pitch angle at the first pitch knot point (K=5) of the support cycle may be calculated, time b at the next pitch knot point (K=5′) may be calculated based on the calculated angle difference c, the length L of the leg and the walking velocity v, and the time at the next pitch knot point (K=5) may be corrected to the calculated time b at the next pitch knot point (K=5′). An equation to calculate the time at the next pitch knot point may be as follows.

b=(c×L)/v

Here, the time b at the next pitch knot point (K=5′) may be calculated based on the calculated angle difference c, the height of the COM and the walking velocity v.

Further, in order to maintain the walking velocity of the walking robot, the walking robot may judge time at a position where a first line connecting the pitch knot point (K=4) when the foot of the swing leg normally contacts a surface and the next pitch knot point (K=5) and a second line extending from the pitch knot point (K=4′) when the foot actually contacts a surface intersect, calculate a time difference between the judged time and the time at the pitch knot point (K=5), and set the calculated time difference as the time b.

Further, the walking robot may calculate a time difference between the time at the previous pitch knot point (K=3) and the time at the pitch knot point (K=4′) when the foot actually contacts the ground, and set the calculated time difference as the time b.

By correcting the time at the next pitch knot point, as described above, control time from the pitch knot point when the right leg contacts a surface early to the next pitch knot point may be shortened, thereby maintaining the walking velocity of the robot.

Thereafter, the robot may generate a target pitch angle trajectory during the support cycle by connecting the pitch knot point (K=4′) when the foot contacts a surface early, the next pitch knot point (K=5′) with the shortened time and a subsequent pitch knot point (K=6′) by a spline.

Here, time at the pitch knot point (K=6′) may be merely shortened by shortening the time at the pitch knot point (K=5′), and a time interval between the two pitch knot points (K=5′, 6′) may be equal to a time interval between the two pitch knot points (K=5, 6).

Here, the leg may be the swing leg. Further, time at the next pitch knot point of the support leg may be shortened. Further, time at the next roll knot point of a roll knot point may be shortened.

The walking robot may execute support through the right leg while tracking the target angle trajectory during the shortened support cycle, and may generate knot points (K=7′, 8′) to execute the next state based on the pose during execution of support.

Here, the swing cycle formed by the knot points (K=6′, 7′, 8′) may be equal to the previous swing cycle, but time of the swing cycle may be merely moved up by shortening the next support cycle due to early contact of the foot with a surface at the previous swing cycle formed by the knot points (K=3, 4, 5).

Further, time at all the pitch knot points within the support cycle may be shortened.

For example, the walking robot may calculate an angle difference between the pitch angle at the pitch knot point (K=4′) when the foot actually contacts a surface and the pitch angle at the final pitch knot point (K=6) of the support cycle, i.e., the pitch knot point when the foot is lifted off the ground, may calculate shortening time based on the calculated angle difference, the length of the leg and the walking velocity, and may apply half of the calculated shortening time to each of time at the pitch knot points (K=5′, 6′) within the support cycle.

Here, a time interval between the two pitch knot points (K=5′, 6′) may be different from a time interval between the two pitch knot points (K=5, 6).

FIG. 8 is an exemplary view illustrating knot points and a target pitch angle trajectory if the current pitch angle of the hip joint is less than the pitch angle at the first pitch knot point within the support cycle (c<=0) under the condition that the swing leg contacts a surface early.

As shown in FIG. 8, the walking robot may generate a pitch knot point (K=6′) formed by shortening time at the final pitch knot point within the next support cycle, i.e., the pitch knot point (K=6) when the foot is lifted off the ground.

In more detail, if the swinging right leg normally contacts the ground, time required for control from the angle at the pitch knot point (K=4) to the angle at the pitch knot point (K=6) may be a.

However, if the swinging right leg contacts a surface early, when the support cycle is controlled for the time a in spite of a small pitch angle variation, the walking velocity may decrease. Therefore, in order to maintain the walking velocity, a time value at the pitch knot point (K=6′) may need to be adjusted.

Here, shortening of the pitch knot point when the foot is lifted off a surface may be carried out as follows. An angle difference d between the pitch angle at the pitch knot point (K=4′) at the point of time when the foot actually contacts a surface and the pitch angle at the final pitch knot point (K=6) of the support cycle may be calculated, time e at the next pitch knot point (K=6′) may be calculated based on the calculated angle difference d, the length L of the leg and the walking velocity v, and the time at the next pitch knot point (K=6) may be corrected to the calculated time e at the next pitch knot point (K=6′). An equation to calculate the time at the next pitch knot point may be as follows.

e=(d×L)/v

Here, the time e at the next pitch knot point (K=6′) may be calculated based on the calculated angle difference d, the height of the COM and the walking velocity v.

By correcting the time at the pitch knot point of the support cycle, as described above, control time from the pitch knot point when the right leg contacts a surface early to the next pitch knot point may be shortened, thereby maintaining the walking velocity of the robot.

Thereafter, the robot may generate a target pitch angle trajectory during the support cycle by connecting the pitch knot point (K=4′) when the foot contacts a surface early and the next pitch knot point (K=6′) with the shortened time by a spline.

Here, the leg is the swing leg. Further, time at the next pitch knot point of the support leg may be shortened. Further, time at the next roll knot point of a roll knot point may be shortened.

The walking robot may execute support through the right leg while tracking the target angle trajectory during the shortened support cycle, may generate knot points (K=7′, 8′) to execute the next state based on the pose during execution of support, and may generate a target pitch angle trajectory by connecting the pitch knot point (K=6′) and the newly generated knot points (K=7′, 8′) by a spline.

Here, the swing cycle formed by the knot points (K=6′, 7′, 8′) may be equal to the previous swing cycle, but time of the swing cycle may merely be moved up by shortening the next support cycle formed by the knot points (K=4′ 6′) due to early contact of the foot with a surface at the previous swing cycle formed by the knot points (K=3, 4, 5).

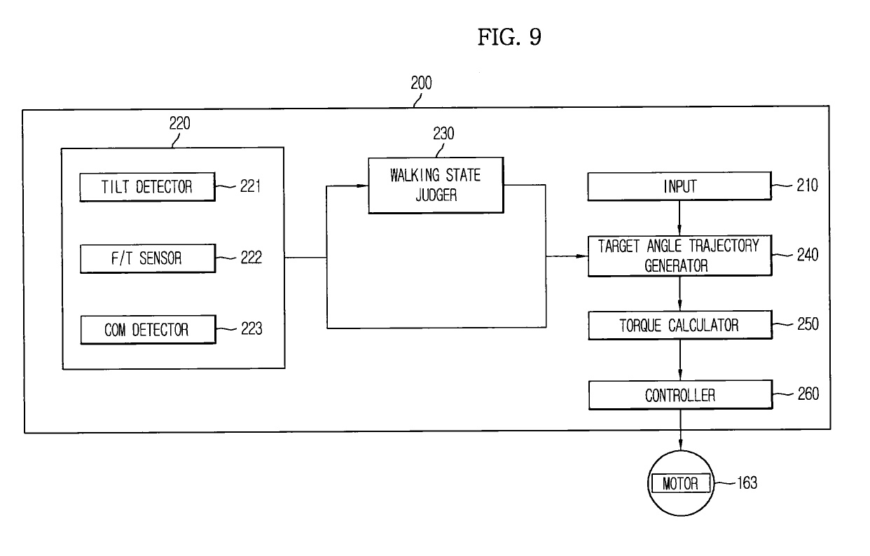

FIG. 9 is a block diagram of a walking control apparatus 200 of a walking robot in accordance with one or more embodiments. The walking control apparatus 200 of the walking robot may include, for example, an input 210, a pose detector 220, a walking state judger 230, a target angle trajectory generator 240, a torque calculator 250, and a controller 260.

The input 210, the pose detector 220, the walking state judger 230, the walking state judger 240, the torque calculator 250 and the controller 260 in this embodiment may be equal to those in the former embodiment, and a detailed description thereof will thus be omitted.

The pose detector 220 further may include a center of mass (COM) detector 223.

The COM detector 223 may detect the COM of the robot based on the torso tilt data detected by the tilt detector 221 and the rotating angles of the respective joints 131, 143, 144, 163, 164 and 165 corresponding to the current pose of the robot, may calculate variation of the detected COM, and may transmit the calculated variation of the COM to the target angle trajectory generator 240.

Here, the rotating angles of the respective joints may be measured using RPMs of plural motors (not shown) provided at the respective joints. The RPMs of the respective motors may be detected through encoders (not shown) connected to the respective motors.

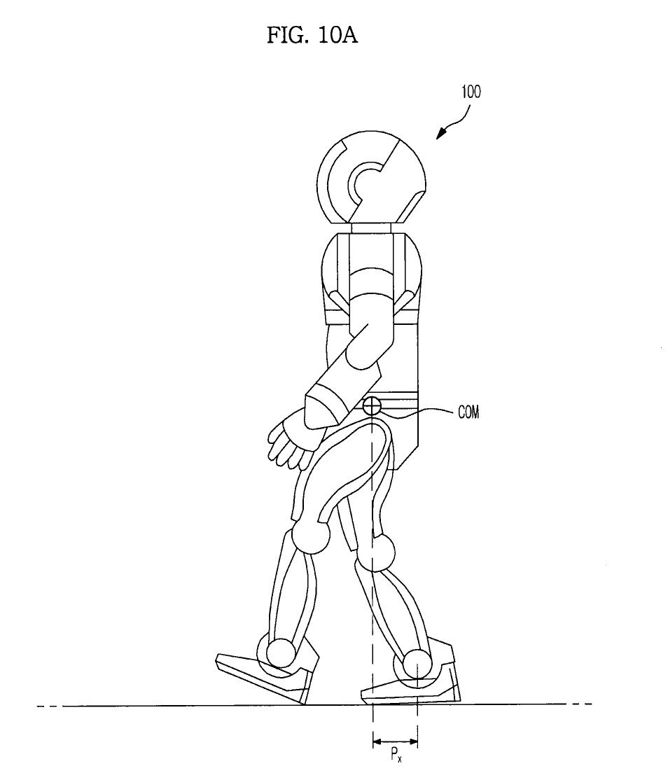

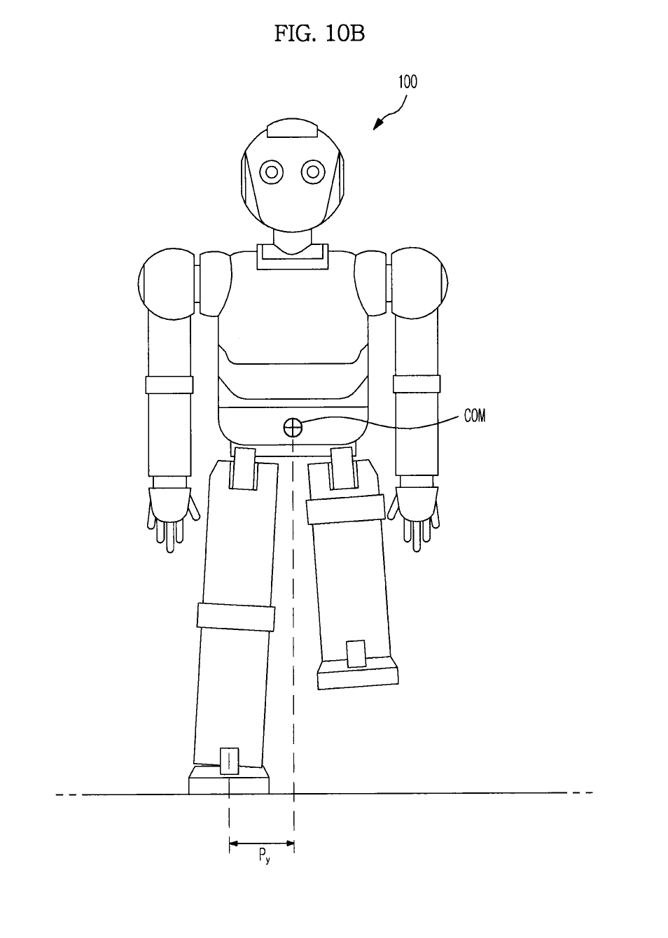

As shown in FIGS. 10A and 10B, the COM detector 223 may calculate variation Px of the COM of the robot in the walking direction (in the X-axis direction) and variation Py of the COM of the robot in the lateral direction (in the Y-axis direction).

Here, the variations Px and Py of the COM may be a distance in the X-axis direction and a distance in the Y-axis direction between the position of the vertical line of the COM of the robot and the position of the ankle of a foot contacting the ground.

That is, because the robot may keep balance only if the vertical line of the COM of the robot coincides with the position of the ankle of the support leg during walking of the robot, the distance in the X-axis direction and the distance in the Y-axis direction between the position of the vertical line of the COM of the robot and the position of the ankle of the foot contacting a surface may be detected.

The target angle trajectory generator 240 may generate angles of the rotary joints provided at the plural joints 163, 164 and 165 based on the respective state data judged by the walking state judger 230 as knot points, and may generate target angle trajectories of the plural rotary joints provided at the plural joints 163, 164 and 165 by connecting the knot points.

The target angle trajectory generator 240 may correct times and angles at the next knot points based on current variation of the COM, may generate target angle trajectories by connecting the corrected knot points, and may transmit the generated target angle trajectories to the torque calculator 250.

Here, the target angle trajectory generator 240 may judge variation of the COM in the Y-axis direction, may calculate roll angle and time compensation values by comparing the judged variation of the COM in the Y-axis direction with a reference variation in the Y-axis direction, and may correct the next roll knot point using the calculated roll angle and time compensation values.

The target angle trajectory generator 240 may shorten the next support cycle, upon judging that the swing leg contacts a surface prior to the prestored time under the condition that the next roll knot point is corrected based on the variation of the COM.

Here, shortening of the support cycle in this embodiment may be equal to shortening of the support cycle in the former embodiment.

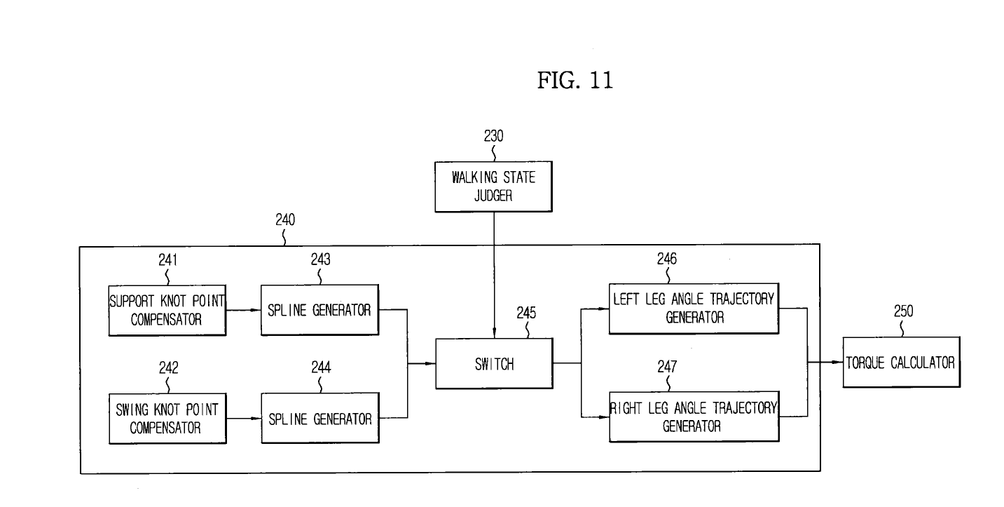

Hereinafter, the target angle trajectory generator 240 will be described in more detail with reference to FIG. 11.

FIG. 11 is a block diagram illustrating a detailed configuration of the target angle trajectory generator 240 of the walking robot in accordance with one or more embodiments. The target angle trajectory generator 240 may include a support knot point compensator 241, a swing knot point compensator 242, spline generators 243 and 244, a switch 245, a left leg angle trajectory generator 246, and a right leg angle trajectory generator 247.

The support knot point compensator 241 may regenerate a roll knot point of the hip joint 163 of the support leg by calculating angle and time compensation values Δr and ΔT of the roll knot point of the hip joint 163 of a leg which will be the next support leg.

The swing knot point compensator 242 may regenerate a roll knot point of the hip joint 163 of the swing leg by calculating angle and time compensation values Δr and ΔT of the roll knot point of the hip joint 163 of a leg which will be the next swing leg.

The angle and time compensation values calculated by the support knot point compensator 241 and the swing knot point compensator 242 may be different.

The spline generator 243 may generate a target roll angle trajectory of the hip joint 163 of the support leg by connecting roll knot points of the hip joint 163 of the support leg by a spline.

The spline generator 244 may generate a target roll angle trajectory of the hip joint 163 of the swing leg by connecting roll knot points of the hip joint 163 of the swing leg by a spline.

If times and angles at the roll knot points are not compensated for, target roll angle trajectories may be generated by connecting the finally generated roll knot points of the first support leg and swing leg.

The switch 245 may judge the support and swing legs corresponding to the walking state data (0 or 1) of the respective legs transmitted from the walking state judger 230, and may transmit the support target roll angle trajectory of the hip joint 163 to the support leg and may transmit the swing target roll angle trajectory of the hip joint 163 to the swing leg according to a result of judgment.

The switch 245 may achieve switching between the support state and the swing state of each of the feet based on contact signals detected by the F/T sensors 222 when the two feet respectively contact the ground.

The left leg angle trajectory generator 246 may generate a target roll angle trajectory which is to be tracked by the hip joint 163 of the left leg according to the data transmitted from the switch 245, and may transmit the target roll angle trajectory to the torque calculator 250.

The right leg angle trajectory generator 247 may generate a target roll angle trajectory which is to be tracked by the hip joint 163 of the right leg according to the data transmitted from the switch 245, and may transmit the target roll angle trajectory to the torque calculator 250.

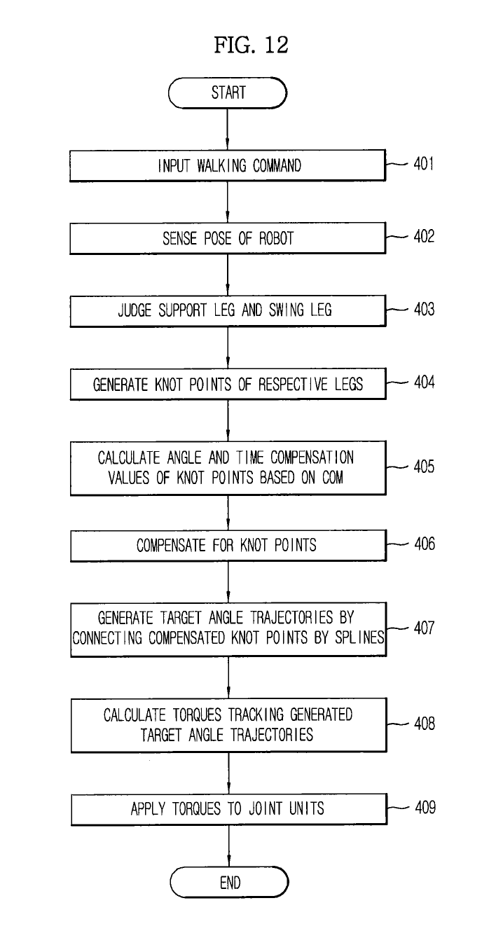

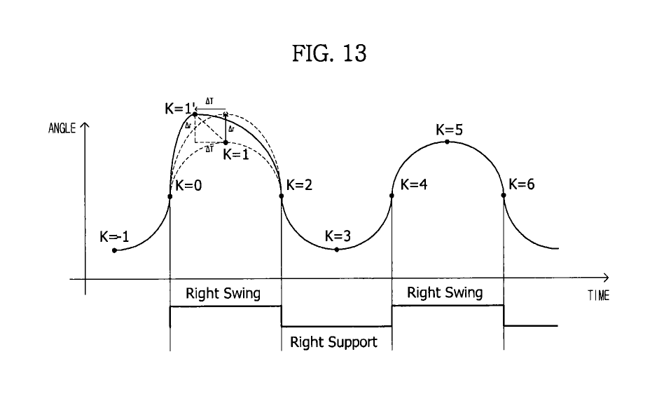

FIG. 12 is a flowchart illustrating a control method of the walking robot in accordance with one or more embodiments. Hereinafter, the control method of the walking robot will be described with reference to FIGS. 12 and 13.

When a walking command is input through the input 210 (Operation 401), the walking robot 100 may control walking at a predetermined walking velocity. Further, the walking robot 100 may receive a walking velocity through the input 210.

The walking robot 100 may detect a pose of the robot 100 during walking control (Operation 402). Here, loads applied to the respective ankles may be judged.

The walking robot 100 may judge a support leg contacting a surface to support the body of the robot 100 and a swing leg lifted off a surface to swing in a space based on the loads applied to the respective ankles (Operation 403).

The walking robot 100 may generate knot points of the respective joints 163, 164 and 165 of a leg which will be the next swing leg and knot points of the respective joints 163, 164 and 165 of a leg which will be the next support leg based on a result of judgment as to the support leg and the swing leg (Operation 404).

For example, if the right leg is in the swing state and the left leg is in the support state at the current walking cycle, knot points of the right leg in the support state and knot points of the left leg in the swing state may be generated in order to execute the next walking cycle.

That is, knot points within the support cycle executing the support state and knot points within the swing cycle executing the swing state may be generated.

The knot points within the swing cycle and the support cycle of the target angle trajectory of one leg may be generated based on the walking progress state, and thus have different time values.

The walking robot 100 may detect the COM during generation of the next knot points based on the pose of the robot 100, may judge variation of the detected COM, and may correct time and angle at knot points based on the judged variation of the COM. Here, roll knot points corresponding to the rotary joint of the hip joint in the roll direction may be corrected.

In more detail, the robot 100 may calculate time and angle compensation values of the roll knot points by comparing current actual variation data of the COM with reference variation data of the COM (Operation 405).

That is, the walking robot 100 may calculate angle and time compensation values Δr and ΔT of the roll knot point of the hip joint 163 by comparing an actual variation Py of the COM in the Y-axis direction with a reference variation Pr of the COM in the Y-axis direction.

Thereafter, the walking robot 100 may compensate for the next roll knot point by applying the angle and time compensation values Δr and ΔT to the next roll knot point (Operation 406), thereby generating a target roll knot point of the hip joint 163.

Here, the next roll knot point of the swing leg may be corrected. Further, the next roll knot point of the support leg may be corrected.

If the roll knot point of the hip joint is changed by the COM in such a manner, target roll angle trajectories of the hip joints units 163 of the support leg and the swing leg may be generated by respectively connecting roll knot points of the hip joints 163 of the support leg and the swing leg by splines (Operation 407).

Thereafter, the walking robot 100 may calculate torques to track the target roll angle trajectories of the hip joints 163 of the respective legs (Operation 408).

Thereafter, the walking robot 100 may execute pulse-width modulation (PWM) corresponding to the respective torques, and then may apply the torques to the motors (not shown) provided at the hip joints 163 (Operation 309), thereby rotating the motors.

This will be described in detail with reference to FIG. 13.

FIG. 13 is an exemplary view illustrating a target roll angle trajectory of the hip joint 163 of the right leg 160R of the walking robot in accordance with one or more embodiments according to time during walking, i.e., illustrating regeneration of a target roll angle trajectory according to variation of the COM.

The robot may generate roll knot points (K=1, 2) for swinging under the condition that the right leg is in the support state, may generate roll knot points (K=3, 4) for supporting under the condition that the right leg is in the swing state, and may generate roll knot points (K=5, 6) for swinging under the condition that the right leg is in the support state.

First, the robot may generate the roll knot points (K=1, 2) to execute the next state at the current knot point (K=0).

Here, the robot may judge variations Px and Py of the COM at the current knot point (K=0), and may maintain the values of the generated knot points (K=1, 2 . . . ) and may generate a target roll angle trajectory by connecting the knot points (K=1, 2 . . . ) by a spline if the variations Px and Py of the COM coincide with reference variations of the COM.

On the other hand, if the variations Px and Py of the COM do not coincide with the reference variations of the COM due to external force or environmental change, the walking robot may judge variations Px and Py of the COM at the current knot point (K=0), may generate the next roll knot point (K=1′) by calculating velocities Px′ and Py′ of the COM, and may generate a target roll angle trajectory by connecting the current knot point (K=0) and the next roll knot point (K=1′).

That is, if the variations Px and Py of the COM coincide with reference variations of the COM, the roll knot point (K=1) may be generated, and if the variations Px and Py of the COM do not coincide with the reference variations of the COM, the roll knot point (K=1′) according to the variations of the COM may be generated.

An equation to calculate time and angle compensation values of the next roll knot point based on the COM may be as follows. Here, Proportional-Derivative (PD) control may be used.

Δr=Kp1(Py−Pr)+Kd1(Py′−Pr′)

ΔT=Kp2(Py−Pr)+Kd2(Py′−Pr′)

Here, Kp1 and Kp2 are P gains of PD control, and Kd1 and Kd2 are D gains of PD control. The P and D grains enable the walking robot 100 to possibly execute optimally stable walking, and may be obtained through repetitive experimentation.

Py may be an actual variation of a distance between the position of the vertical line of the COM of the robot and the position of the ankle of the foot contacting a surface in the Y-axis direction, and Py′ may be an actual velocity obtained by differentiating the actual distance. Here, the actual velocity Py′ may be directly detected.

Further, Pr may be a reference variation of a distance in the Y-axis direction corresponding to the walking direction of the walking robot, and Pr′ may be a reference velocity obtained by differentiating the reference distance.

Further, the walking robot may correct the roll knot point only if the actual distance exceeds the reference distance.

Thereafter, the walking robot may generate a target roll angle trajectory by connecting the current roll knot point (K=0), the next roll knot point (K=1′) with the corrected time and angle, and subsequent roll knot points by a spline.

Thereafter, the walking robot 100 may calculate torques to track generated target roll angle trajectories, may execute PWM of current to output the calculated torques, and may apply the calculated torques to the hip joints 163 of the respective legs.

During calculation of the torques applied to the motors, the walking robot 100 may use Proportional-Derivative (PD) control.

Further, in order to track the calculated torques, Proportional-Integral-Derivative (PID) control may be used.

As is apparent from the above description, a walking control method of walking robot in accordance with one or more embodiments may use an FSM control structure and torque servo control, and may thus have advantages given below as compared to the conventional walking control method.

In order to maintain balance during walking if external force is applied to the robot or environment is changed, time and angle of the next knot point may be adjusted, thereby possibly achieving flexible and stable walking of the robot.

Further, precise control of rotating angles of respective joints during walking may not be required and thus walking of the robot may be executed at low servo gain and energy consumption may be reduced as compared to conventional walking, and the respective joints may have low stiffness and thus impact applied to the robot when the robot collides with the surrounding environment may be reduced.

Further, since walking of the robot with stretched knees which may be disabled through the conventional walking method requiring calculation of inverse kinematics may be enabled, human friendliness of the robot may be improved, energy consumed during bending of the knees may be reduced, and the robot may achieve a 3-fold increase in walking velocity.

Further, since calculation of the complicated dynamic equation is not required, walking of a robot having 6 degrees of freedom may be controlled.

Moreover, since knot points of the respective joints may be connected by splines, walking of the robot maximally similar to walking of a human may be achieved.

In one or more embodiments, any apparatus, system, element, or interpretable unit descriptions herein include one or more hardware devices or hardware processing elements. For example, in one or more embodiments, any described apparatus, system, element, retriever, pre or post-processing elements, tracker, detector, encoder, decoder, etc., may further include one or more memories and/or processing elements, and any hardware input/output transmission devices, or represent operating portions/aspects of one or more respective processing elements or devices. Further, the term apparatus should be considered synonymous with elements of a physical system, not limited to a single device or enclosure or all described elements embodied in single respective enclosures in all embodiments, but rather, depending on embodiment, is open to being embodied together or separately in differing enclosures and/or locations through differing hardware elements.

In addition to the above described embodiments, embodiments can also be implemented through computer readable code/instructions in/on a non-transitory medium, e.g., a computer readable medium, to control at least one processing device, such as a processor or computer, to implement any above described embodiment. The medium can correspond to any defined, measurable, and tangible structure permitting the storing and/or transmission of the computer readable code.

The media may also include, e.g., in combination with the computer readable code, data files, data structures, and the like. One or more embodiments of computer-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Computer readable code may include both machine code, such as produced by a compiler, and files containing higher level code that may be executed by the computer using an interpreter, for example. The media may also be any defined, measurable, and tangible distributed network, so that the computer readable code is stored and executed in a distributed fashion. Still further, as only an example, the processing element could include a processor or a computer processor, and processing elements may be distributed and/or included in a single device.

The computer-readable media may also be embodied in at least one application specific integrated circuit (ASIC) or Field Programmable Gate Array (FPGA), as only examples, which execute (e.g., processes like a processor) program instructions.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A walking robot comprising:
hip joints respectively provided at plural legs;
a pose detector to detect a pose of the walking robot;
a walking state judger to judge a walking state from the pose;
a target angle trajectory generator to judge a support leg and a swing leg based on the walking state, to judge whether or not the swing leg contacts a surface prior to a predetermined time when the walking state of the plural legs is changed, to shorten a next support cycle executed by the swing leg when the swing leg contacts the surface prior to the predetermined time, and to generate target angle trajectories of the hip joints based on the shortened support cycle;
a torque calculator to calculate torques tracking the target angle trajectories of the hip joints; and
a controller to output the torques to the hip joint to control walking of the walking robot.

2. The walking robot according to claim 1, wherein the target angle trajectory generator generates plural knot points within the next support cycle of the hip joint of the swing leg based on the pose during a swing cycle when one of the plural legs is in a swing state.

3. The walking robot according to claim 1, wherein the target angle trajectory generator shortens a time at a first knot point of the next support cycle of the hip joint of the swing leg based on an angle difference between an angle when the swing leg contacts the surface and an angle at the first knot point of the next support cycle when the swing leg contacts the surface prior to the predetermined time.

4. The walking robot according to claim 1, wherein the target angle trajectory generator shortens a time at a final knot point of the next support cycle of the hip joint of the swing leg based on an angle difference between an angle when the swing leg contacts the surface and an angle at the final knot point of the next support cycle when the swing leg contacts the surface prior to the predetermined time.

5. The walking robot according to claim 1, wherein the plural knot points include at least one of a pitch knot point and a roll knot point of the hip joint.

6. The walking robot according to claim 1, wherein:
the pose detector comprises force and torque (F/T) sensors to detect forces or torques transmitted to feet of the plural legs; and
the walking state judger judges the support leg and the swing leg based on the forces or torques transmitted to the feet.

7. The walking robot according to claim 1, wherein the target angle trajectory generator judges a time at a knot point when the swing leg normally contacts the surface, and prestores the time.

8. The walking robot according to claim 7, wherein the target angle trajectory generator judges whether or not the swing leg contacts the surface prior to the predetermined time by comparing a time when the swing leg actually contacts the surface with a time when the swing leg normally contacts the ground.

9. A walking robot comprising:
hip joints respectively provided at plural legs;
a pose detector to detect a pose of the walking robot;
a walking state judger to judge a walking state from the pose;
a target angle trajectory generator to judge a support leg and a swing leg based on the walking state, to generate plural knot points of the hip joints of the respective legs according to time, to calculate angle and time compensation values of next knot points by detecting the center of mass (COM) from the pose, to correct times and angles at the next knot points based on the angle and time compensation values, and to generate target angle trajectories of the hip joints using the next knot points with the corrected times and angles;
a torque calculator to calculate torques tracking the target angle trajectories of the hip joints; and
a controller to output the torques to the hip joints to control walking of the walking robot.

10. The walking robot according to claim 9, wherein the target angle trajectory generator corrects time and angle of a next knot point of the swing leg.

11. The walking robot according to claim 9, wherein the target angle trajectory generator generates a target angle trajectory by connecting roll knot points of the hip joint by a spline.

12. The walking robot according to claim 11, wherein the target angle trajectory generator judges a variation of the COM in the Y-axis direction, and calculates roll angle and time compensation values by comparing the judged variation of the COM in the Y-axis direction with a reference variation of the COM in the Y-axis direction.

13. The walking robot according to claim 9, wherein the target angle trajectory generator judges whether or not the swing leg contacts a surface prior to a predetermined time based on the walking state, shortens the next support cycle executed by the swing leg when the swing leg contacts the surface prior to the predetermined time, and generates the target angle trajectory of the hip joint of the swing leg based on the shortened support cycle.

14. The walking robot according to claim 13, wherein the target angle trajectory is a target pitch angle trajectory of the hip joint of the swing leg.

15. The walking robot according to claim 13, wherein the target angle trajectory generator calculates time of the next support cycle based on an angle when the swing leg contacts the ground, a walking velocity and a predetermined leg length upon judging that the swing leg contacts the surface prior to the predetermined time.

16. The walking robot according to claim 13, wherein the target angle trajectory generator calculates a time of the next support cycle based on a pitch angle when the swing leg contacts the ground, a walking velocity and the height of the COM when the swing leg contacts the surface prior to the predetermined time.

17. A control method of a walking robot comprising:
detecting a pose of the walking robot at the current cycle during walking with plural legs;
respectively generating, using a processor, knot points of the plural legs within a next cycle based on the detected pose of the walking robot;
judging a swing leg and a support leg among the plural legs by judging a walking state from the pose of the walking robot;
judging whether or not the swing leg contacts a surface prior to a predetermined time;
shortening a time at the knot points within the support cycle executed by the swing leg when the swing leg contacts the surface prior to the predetermined time;
generating target angle trajectories of the hip joints using the knot points having the shortened time within the support cycle;
calculating torques tracking the target angle trajectories of the hip joints; and
outputting the torques to the hip joints to control walking of the walking robot.

18. The control method according to claim 17, wherein the shortening of the time at the knot points within the support cycle comprises shortening the time of at least one knot point of a pitch knot point and a roll knot point of the hip joint of the swing leg.

19. The control method according to claim 18, wherein the shortening of the time at the at least one knot point comprises:
judging whether or not a pitch angle of the hip joint when the swing leg contacts the surface is greater than a pitch angle at the first knot point of the support cycle;
calculating an angle difference between the pitch angle of the hip joint when the swing leg contacts the surface and the pitch angle at the first knot point of the support cycle when the pitch angle of the hip joint when the swing leg contacts the surface is greater than the pitch angle at the first knot point of the support cycle;
calculating a time based on the angle difference, a predetermined walking velocity and a leg length of the walking robot; and
shortening the time at the first pitch knot point within the support cycle to the calculated time.

20. The control method according to claim 18, wherein the shortening of the time at the at least one knot point comprises:
judging whether or not a pitch angle of the hip joint when the swing leg contacts the surface is greater than a pitch angle at the first knot point of the support cycle;
calculating an angle difference between the pitch angle of the hip joint when the swing leg contacts the surface and a pitch angle at the final knot point of the support cycle when the pitch angle of the hip joint when the swing leg contacts the surface is less than the pitch angle at the first knot point of the support cycle;
calculating a time based on the angle difference, a predetermined walking velocity and a leg length of the walking robot; and
shortening the time at the final pitch knot point within the support cycle to the calculated time.

21. The control method according to claim 17, wherein the generation of the target angle trajectory of the hip joint comprises generating a target angle trajectory of the hip joint of the swing leg by connecting the knot points with the shortened time by a spline.

22. The control method according to claim 17, further comprising acquiring a time at a knot point when the swing leg normally contacts the surface and prestoring the time.

23. The control method according to claim 17, wherein the judging whether or not the swing leg contacts the surface prior to a predetermined time comprises:
comparing a time when the swing leg actually contacts the surface with a time when the swing leg normally contacts the ground; and
judging that the swing leg contacts the surface prior to a predetermined time when the time when the swing leg actually contacts the surface is earlier than the time when the swing leg normally contacts the ground.

24. A control method of a walking robot comprising:
detecting a pose of the walking robot walking with plural legs;
judging a swing leg and a support leg by judging a walking state from the pose of the walking robot;
generating next knot points of hip joints of the respective legs according to time;
calculating angle and time compensation values at the next knot points by detecting the center of mass (COM) of the walking robot from the pose of the walking robot;
correcting times and angles at the next knot points based on the angle and time compensation values;
generating target angle trajectories of the hip joints using the next knot points with the corrected times and angles;
calculating torques tracking the target angle trajectories of the hip joints; and
outputting the torques to the hip joints to control walking of the walking robot.

25. The control method according to claim 24, wherein the correction of times and angles at the next knot points comprises correcting a time and an angle at the next roll knot point of the swing leg.

26. The control method according to claim 24, wherein the calculation of the angle and time compensation values at the next knot points comprises:
judging a variation of the COM in the Y-axis direction; and
calculating roll angle and time compensation values by comparing the judged variation of the COM in the Y-axis direction with a reference variation of the COM in the Y-axis direction.

27. The control method according to claim 26, wherein the variation of the COM in the Y-axis direction comprises a distance variation of the COM in the Y-axis direction and a velocity variation of the COM in the Y-axis direction.

28. The control method according to claim 24, further comprising:
judging whether or not the swing leg contacts a surface prior to a predetermined time based on the walking state;
shortening a time at pitch knot points within the support cycle of the swing leg when the swing leg contacts the surface prior to the predetermined time; and
generating a target angle trajectory of the hip joint of the swing leg using the pitch knot points with the shortened time within the support cycle.

29. A control method of a walking robot comprising:
respectively generating, using a processor, knot points of plural legs within a next cycle of walking with the plural legs;
judging a swing leg and a support leg among the plural legs by judging a walking state of the walking robot;
judging whether or not the swing leg contacts a surface prior to a predetermined time;
shortening a time at the knot points within the support cycle executed by the swing leg when the swing leg contacts the surface prior to the predetermined time; and
generating target angle trajectories of the hip joints using the knot points having the shortened time within the support cycle.

30. The control method according to claim 18, wherein the shortening of the time at the knot points within the support cycle comprises:
judging whether or not a pitch angle of the hip joint when the swing leg contacts the surface is greater than a pitch angle at the first knot point of the support cycle;
calculating an angle difference between the pitch angle of the hip joint when the swing leg contacts the surface and the pitch angle at the first knot point of the support cycle when the pitch angle of the hip joint when the swing leg contacts the surface is greater than the pitch angle at the first knot point of the support cycle;
calculating a time based on the angle difference, a predetermined walking velocity and a leg length of the walking robot; and
shortening the time at the first pitch knot point within the support cycle to the calculated time.

31. The control method according to claim 18, wherein the the shortening of the time at the knot points within the support cycle comprises:
judging whether or not a pitch angle of the hip joint when the swing leg contacts the surface is greater than a pitch angle at the first knot point of the support cycle;
calculating an angle difference between the pitch angle of the hip joint when the swing leg contacts the surface and a pitch angle at the final knot point of the support cycle when the pitch angle of the hip joint when the swing leg contacts the surface is less than the pitch angle at the first knot point of the support cycle;
calculating a time based on the angle difference, a predetermined walking velocity and a leg length of the walking robot; and
shortening the time at the final pitch knot point within the support cycle to the calculated time.

32. The walking robot according to claim 1, wherein the a target angle trajectory generator comprises:
a support knot point compensator to regenerate a roll knot point of the hip joint of the support leg;
a swing knot point compensator to regenerate a roll knot point of the hip joint of the swing leg;
a first spline generator to generate a target roll angle trajectory of the hip joint of the support leg;
a second spline generator to generate a target roll angle trajectory of the hip joint of the swing leg;
a switch to judge the support and swing legs corresponding to the walking state data;
a left leg angle trajectory generator to generate a target roll angle trajectory to be tracked by the hip joint of the left leg; and
a right leg angle trajectory generator to generate a target roll angle trajectory to be tracked by the hip joint of the right leg.
